(19) United States
(12) Patent Application Publication
(10) Pub. No.: US 2015/0334314 A1
(43) Pub. Date: Nov. 19, 2015

(54) DEVICE AND METHOD FOR DETECTING THERMAL IMAGES

(71) Applicant: MISSION INFRARED ELECTRO OPTICS TECHNOLOGY CO., LTD, Hangzhou, Zhejiang (CN)

(72) Inventor: Hao Wang, Hangzhou (CN)

(21) Appl. No.: 14/758,247

(22) PCT Filed: Dec. 27, 2013
(86) PCT No.: PCT/CN2013/090628

§ 371 Date: Jun. 29, 2015

(30) Foreign Application Priority Data
Dec. 27, 2012 (CN) 201210584128.8

(51) Int. Cl. H04N 5/33; H04N 5/232

(52) U.S. Cl. CPC H04N 5/33; H04N 5/23293; H04N 5/23229

(57) ABSTRACT

This invention provides a device and method for detecting thermal images, which relates to infrared detection. The conventional thermal imaging device is excessively dependent on subjective experience of users to photograph a thermal image of a photographed body during photographing, causing omissions and failing to ensure the quality of the photographed thermal image. In the invention, a reference image and an infrared thermal image acquired by photographing are displayed together. A user may photograph a body and detect the acquired thermal imaging data frame under the visual reference of the reference image. When the specified body thermal image is detected, the user is informed. Thereby, the technical requirements for the users are reduced, the photographing quality and speed is improved, and the working strength is reduced.

### BACKGROUND OF THE INVENTION

1. Field of the Invention

The invention relates to infrared detection field and, more particularly, to a device and method for detecting thermal images.

2. Description of the Related Art

In the prior art, a reference image reflecting morphological character of a photographed body and an infrared thermal image acquired by photographing are continuously overlapped and displayed, and users may photograph bodies with the visual reference of the reference image, to ensure the position and dimension of a body thermal image in the infrared thermal image and the correction of the morphological character of the body thermal image, thereby ensuring the photographing quality. For example, a patent with a publication number of CN201210008404.6 discloses the above device for photographing thermal images.

However, in the above method, the users may manually judge the matching extent between the reference image and the body thermal image by eyes, thereby easily causing visual fatigue and affecting the photographing speed.

Therefore, a thermal imaging device, without excessively depending on subjective ideas of the users and capable of informing the users when a specified body thermal image is detected, is needed, thereby facilitating the photographing operation and the subsequent processing or operation such as analysis or storage.

### BRIEF SUMMARY OF THE INVENTION

The invention provides a device and method for detecting thermal images. A reference image and an infrared thermal image acquired by photographing are displayed together. With a visual reference of the reference image, users can photograph thermal images of photographed bodies. When it is detected that a photographed thermal image matches body identifying information of a specified body, that is, the specified body thermal image is photographed, the users are informed, thereby reducing technical requirements of the users, improving the photographing quality and speed, and reducing working strength.

This invention provides a device for detecting thermal images, including a photographing part for continuously photographing to acquire a thermal imaging data frame, a display controlling part for controlling to display a reference image and a dynamic infrared thermal image acquired by the acquired thermal imaging data frame, a detecting part for detecting if there is a specified body thermal image in the thermal imaging data frame based on the acquired thermal imaging data frame, and an informing part for performing informing control when the detecting part detects the specified body thermal image.

This invention provides a device for detecting thermal images, including an acquiring part for continuously acquiring a thermal imaging data frame, a display controlling part for controlling to display a reference image and a dynamic infrared thermal image acquired by the acquired thermal imaging data frame, a detecting part for detecting if there is a specified body thermal image in the thermal imaging data frame based on the acquired thermal imaging data frame, and an informing part for performing informing control when the detecting part detects the specified body thermal image.

This invention provides a device for detecting thermal images, including an acquiring part for acquiring a thermal imaging data frame, a display controlling part for controlling to display an infrared thermal image acquired by the acquired thermal imaging data frame and a reference image located in the infrared thermal image, a detecting part for detecting if there is a specified body thermal image in the thermal imaging data frame based on the acquired thermal imaging data frame, and an informing part for performing informing control when the detecting part detects the specified body thermal image.

This invention provides a method for detecting thermal images, including a photographing step for continuously photographing to acquire a thermal imaging data frame, a display controlling step for controlling to display a reference image and a dynamic infrared thermal image acquired by the acquired thermal imaging data frame, a detecting step for detecting if there is a specified body thermal image in the thermal imaging data frame based on the acquired thermal imaging data frame, and an informing step for performing informing control when the specified body thermal image is detected in the detecting step.

This invention provides a method for detecting thermal images, including an acquiring step for continuously acquiring a thermal imaging data frame, a display controlling step for controlling to display a reference image and a dynamic infrared thermal image acquired by the acquired thermal imaging data frame, a detecting step for detecting if there is a specified body thermal image in the thermal imaging data frame based on the acquired thermal imaging data frame, and an informing step for performing informing control when the specified body thermal image is detected in the detecting step.

This invention provides a method for detecting thermal images, including an acquiring step for acquiring a thermal imaging data frame, a display controlling step for controlling to display an infrared thermal image acquired by the acquired thermal imaging data frame and a reference image located in the infrared thermal image, a detecting step for detecting if there is a specified body thermal image in the thermal imaging data frame based on the thermal imaging data frame acquired in the acquiring step, and an informing step for performing informing control when the specified body thermal image is detected in the detecting step.

These and other aspects and advantages of the present invention will be described with regard to the following description.

### BRIEF DESCRIPTION OF THE DRAWINGS

FIG. 1 is a block diagram showing a thermal imaging device 100 as an example of a device for detecting thermal images in a first embodiment of the invention;

FIG. 2 is an outline diagram showing the thermal imaging device 100 in the first embodiment;

FIG. 3 is a schematic diagram showing body information, reference images, and body identifying information stored in a storage medium in the first embodiment;

FIG. 4 is a flow chart of the first embodiment;

FIG. 5 is a schematic diagram showing display interfaces in the first embodiment;

FIG. 6 is a flow chart of a second embodiment;

FIG. 7 is a schematic diagram showing display interfaces in the second embodiment;

FIG. 8 is a flow chart of a third embodiment;

FIG. 9 is a schematic diagram showing display interfaces in the third embodiment;

FIG. 10 is a schematic diagram showing multiple detecting windows set in a specified detecting area;

FIG. 11 is a schematic diagram showing multiple detecting windows;

FIG. 12 is a schematic diagram showing display interfaces in a fourth embodiment;

FIG. 13 is a flow chart of the fourth embodiment;

FIG. 14 is a flow chart of a fifth embodiment;

FIG. 15 is a schematic diagram showing display interfaces in the fifth embodiment;

FIG. 16 is a flow chart of a sixth embodiment;

FIG. 17 is a schematic diagram showing display interfaces in the sixth embodiment.

### DETAILED DESCRIPTION OF THE INVENTION

This invention may be further described according to the drawings. For better understanding, the following described embodiments do not limit the scope of the invention and can be changed to different forms in the scope of the invention. Further, although a handheld thermal imaging device is taken for example, the photographing function in the invention is not necessary, and any thermal imaging data source may be used for performing detection of specified bodies. Therefore, the invention is widely applied to thermal image processing devices for reading and broadcasting or displaying and recording thermal images, or receiving and processing the thermal images from outside. The thermal image processing device may be different devices such as a personal computer, a personal digital assistant.

### Embodiment One

In the first embodiment, the thermal imaging device 100 displays a reference image reflecting morphological character of a body and an infrared thermal image acquired by thermal imaging data frame together based on the thermal imaging data frame photographed and acquired by a photographing part 1, detects a correlation degree between the acquired thermal imaging data frame and the reference image based on a detecting window set according to a position parameter of the reference image, and informs users of a judging result acquired by a judging value corresponding to the correlation degree.

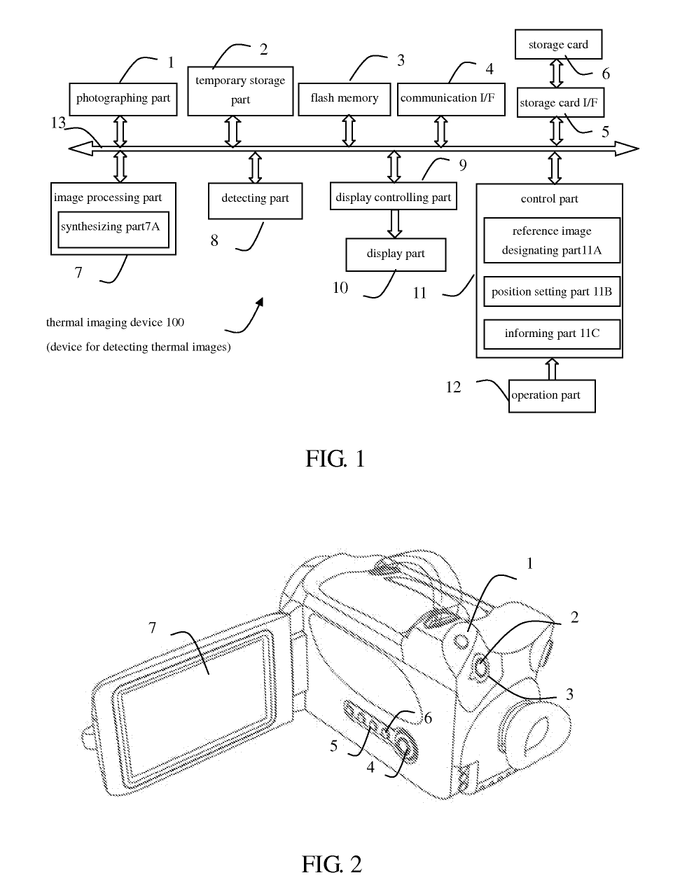

FIG. 1 is a block diagram showing a thermal imaging device 100 as an example of a device for detecting thermal images in the first embodiment of the invention.

In detail, the thermal imaging device 100 includes a photographing part 1, a temporary storage part 2, a flash memory 3, a communication I/F 4, a storage card I/F 5, a storage card 6, an image processing part 7, a detecting part 8, a display controlling part 9, a display part 10, a control part 11, and an operation part 12. The control part 11 is connected with each other part via a control and data bus 13, and is responsible for overall control of the thermal imaging device 100.

The photographing part 1 includes an optical part, a lens driving part, an infrared detector, and a signal preprocessing circuit, which are not shown. The optical part is composed of infrared optical lenses, and is used for focusing received infrared radiation on the infrared detector. The lens driving part drives the lenses to perform focusing or zooming operation according to a control signal of the control part 10, and the optical part may also be manually regulated. The infrared detector such as a refrigerating or non-refrigerated infrared focal plane detector converts the infrared radiation passing through the optical part to electrical signals. The signal preprocessing circuit, including a sample circuit, an AD conversion circuit, and a timing trigger circuit, performs signal processing such as sampling for the electric signals output from the infrared detector in a specified period. The signals are converted to digital thermal imaging signals by the AD conversion circuit. The thermal imaging signal may be 14-bit or 16-bit binary data (also called thermal imaging AD value data, AD value data for short). In the first embodiment, the photographing part is as an example of an acquiring part for photographing to acquire thermal imaging data frames.

According to different embodiments of the acquiring part, the called thermal imaging data frame may be a thermal imaging signal (thermal imaging AD value data acquired after AD conversion of the output signal of the infrared detector), image data of infrared thermal images, array data of temperature values, or other data generated based on the thermal imaging signal. In the first embodiment, the called thermal imaging data frame may be the thermal imaging signal.

The temporary storage part 2, such as a RAM or DRAM volatile storage, is a buffer storage for temporarily storing the thermal imaging data frames output from the photographing part 1. For example, it may repeat the following processing, that is, temporarily store the acquired thermal imaging data frames to specified time sets, and delete the previous data frames to store new thermal imaging data frames when the acquiring part (the photographing part 1) acquires the new frames. Meanwhile, the temporary storage part 2 is a working storage of the image processing part 7, detecting part 8, and the control part 11, for temporarily storing the processed data of the image processing part 7 and the control part 11. However, the invention is not limited. A storage or register in the processor such as the image processing part 7, the detecting part 8, or the control part 11 may also be defined as a temporary storage medium.

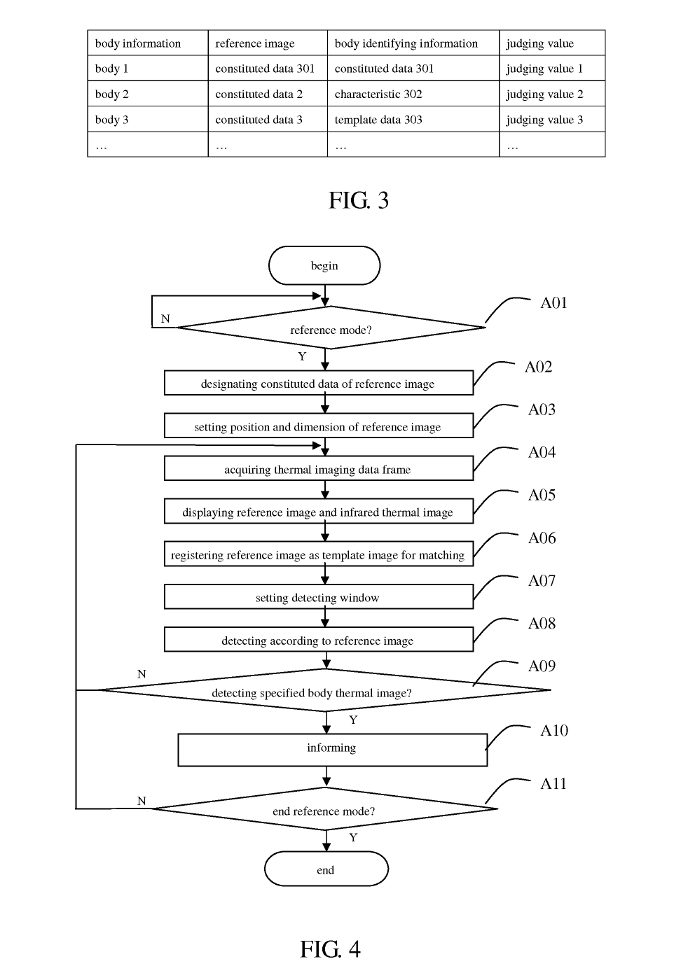

The flash memory 3 stores control programs and different kinds of data used in different control. In the embodiment, as shown in table three in FIG. 3, the data related to the reference image and detection is stored in the storage medium such as the flash memory 3. For example, a database of the body identifying information may be stored, and body information of each body, the constituted data of the reference image, the body identifying information, and the judging values, which correspond to each other, are stored in the database as shown in the table in FIG. 3. In addition, data files with specified formats may store the above information.

The constituted data of the reference image may be vector image data, array image data, or the constituted data of the reference image composed of multiple coordinate points data.

The body information is information related to a body, such as the information representing a place, a type, and a number of the body. In addition, the body information may be the information related to the body, such as an attribution unit, a classified grade (such as a voltage grade or an importance grade), a model, a manufacturer, performance and characteristics, a passed photographing or repairing record, a manufacturing date, or a service life, related to the body. Different applicable body information may be prepared according to different applications.

The communication I/F 4 may be an interface for connecting and exchanging data between the thermal imaging device 100 and an external device according to communication specification such as USB, 1394, or network. The external device may be a personal computer, a server, a PDA (personal digital assistant device), other thermal imaging devices, a visible light photographing device, or a storage device.

The storage card I/F 5 is used as an interface of the storage card 6, and the storage card I/F 5 is connected with the storage card 6. The storage card 6 is as a rewritable non-volatile storage, can be detachably installed in a groove of the main body of the thermal imaging device 100, and can record the data such as the thermal imaging data frames according to the control of a record control part (not shown) of the control part 11.

The image processing part 7 is used for performing specified processing for the thermal imaging data frame acquired by the photographing part 1. For example, as the display timing is achieved every time, it may select and read the frames in each specified time interval from the thermal imaging data frames of the specified time sets temporarily stored in the temporary storage part 2. The image processing part 7 performs processing for converting data to be suitable for displaying or recording, such as modification, interpolation, pseudo-color, synthesis, compression, or decompression. The image processing part 7 may be realized by a DSP, other microprocessors, or a programmable FPGA, or the image processing part 7 may also be integrally formed with the detecting part 8 and the control part 11.

The image processing part 7 is used for performing specified processing for the thermal imaging data frame to acquire the image data of the infrared thermal image. For example, the imaging processing part 7 may perform specified processing such as non-uniformity correction or interpolation for the thermal imaging data frame acquired by the photographing part 1 and then may perform pseudo-color processing for the thermal imaging data frame after the specified processing, to acquire the image data of the infrared thermal image. In one embodiment of the pseudo-color processing, a corresponding range of a pseudo-color plate may be determined according to a range of the thermal imaging data frame AD value or a setting range of the AD value, and the particular color value to which the thermal imaging data frame corresponds in the range of the pseudo-color plate is used as the image data of the corresponding pixel position in the infrared thermal image. The image data acquired after the pseudo-color processing by the image processing part 7 is transferred to the temporary storage part 2 that is used as a buffer storage.

In addition, the image processing part 7 includes a synthesizing part 7A. The synthesizing part 7A acquires the reference image based on the constituted data of the reference image designated by a reference image designating part 11A and a position parameter set by a position setting part 11B, and synthesizes the reference image and the infrared thermal image generated by the image processing part 7 to generate image data of a synthesized image. For example, the synthesizing part 7A may synthesize the reference image and the infrared thermal image according to a specified transparency ratio. When the transparency ratio of the reference image is one (for example, the reference image is lines of an edge contour), the reference image is not-transparently synthesized with the infrared thermal image.

The image processing part 7 is used for performing specified processing for the acquired thermal imaging data frame according to the constituted data of the designated reference image and the position parameter set by the position setting part 11B, to generate the infrared thermal image reflecting the reference image.

In addition, the synthesis may be that the pseudo-color processing is performed for the thermal imaging data frame according to the pixel position of the reference image in the infrared thermal image to generate image data of the reference image and the infrared thermal image for display (similar to an overlapping effect), or may be that the pseudo-color processing is performed for the thermal imaging data except the pixel positions of the reference image according to the pixel positions of the reference image in the infrared thermal image to generate the image data for display by combining the image data of the reference image and the infrared thermal image.

In another example, the processing (such as different pseudo-color processing) for the thermal imaging data of the reference image at the pixel positions in the thermal imaging data frame may be different from the pseudo-color processing for the image data at other pixel positions for generating the infrared thermal image, thus to generate the image reflecting the reference image. At this condition, the synthesizing part 7A for synthesizing the image data of the reference image and the image data of the infrared thermal image may be removed from the thermal imaging device 100.

The reference image is displayed with the infrared thermal image together, to facilitate the users photographing the specified body. For example, the reference image may be an image reflecting the morphological character of the specified body, may be with other shapes, such as square or circular, may be the reference image reflecting an expected imaging position where a body thermal image is located in the infrared thermal image, may be the reference image reflecting a detecting area (the detecting area may include one or more detecting windows) in the infrared thermal image, or may be the reference image reflecting an analysis area of an expected body thermal image. Preferably, the reference image is overlapped and displayed with the infrared thermal image according to the specified position parameter (including a position, a size, or a rotating angle).

In addition, the reference image may be displayed at the area outside of the window of the infrared thermal image on the display part. A thumbnail representing the relation such as the position and dimensional scale of the reference image and the infrared thermal image may be displayed at the area outside of the window of the infrared thermal image on the display part.

The detecting part 8 calculates the correlation degree between the acquired thermal imaging data frame and the body identifying information. For example, under the control of the control part 11, the detecting part 8 may read the thermal imaging data frame acquired by the photographing part 1 stored in the temporary storage part 2 or read the data (such as the image data of the infrared thermal image acquired after the pseudo-color processing) acquired after the specified processing of the image processing part for the thermal imaging data frame acquired by the photographing part 1 from the temporary storage part 2, to perform the detection of the correlation degree between the data and the registered body identifying information.

In other examples, the thermal imaging data frame may be acquired by the externally input data, such as the decompressed thermal imaging data frame received from other thermal imaging devices via the communication I/F 4, and may be acquired from a record medium, such as the thermal imaging data frame acquired by reading a thermal imaging file from the storage card 6. The thermal imaging data frames for detection may be thermal imaging signals (the thermal imaging AD value data), image data of the infrared thermal image, array data of temperature values, or other data acquired according to the thermal imaging signals.

In the first embodiment, the detecting part 8 includes a character registering unit, a detecting window setting unit, a detecting unit, and a judging unit (not shown).

The character registering unit is used for registering the body identifying information related to the calculation of the correlation degree. The body identifying information may be registered according to the body identifying information prestored in the storage medium. For example, according to the body identifying information related to the body information selected by users, the body identifying information for the calculation of the correlation degree may be registered. In addition, the users may designate the body identifying information. For example, the body identifying information (such as template data or extracted characteristics) may be acquired by designating a body area in the displayed image. The registered body identifying information may be stored at a specified position in the temporary storage part 2, or may be stored to make a difference from other stored body identifying information.

The body identifying information may be template data (such as template images) for template matching. For example, in the table in FIG. 3, for a body 1, the template image may be acquired according to constituted data 301 of the reference image reflecting the morphological character of the body. The template data may also be different from the template data of the constituted data of the reference image. For example, a body 3 corresponds to template data 303. In addition, the body identifying information may be characteristics described by parameters. The characteristics (such as points, lines, or planes) may be a value determined by a state of the pixels contained in a detecting window, such as a ratio of specified pixels in the specified detecting window, an average value of pixel values, a center point or an area of a contour of a specified body. For example, for a body 2 in the table in FIG. 3, the body identifying information is the characteristic 302. In detailed application, one kind of the body identifying information or a combination thereof may be used according to conditions.

The detecting window setting unit is used for setting the detecting window. In the embodiment, preferably, the detecting window (such as a bounding rectangle of the reference image) may be set according to the position parameter of the reference image in the infrared thermal image, thereby improving the detecting speed. The detecting window is not limited to be rectangular and may be with other shapes that may be determined by a shape of a template image.

To be equal to the dimension of the detecting window, the template image may be used in a reduced or enlarged state, or the template image with the dimension equal to the window dimension may be prepared and stored. During template matching, the correlation degree between the template image and the window thermal image cut from the thermal imaging data frame via the detecting window may be examined.

The detecting unit compares the thermal imaging data in the read thermal imaging data frame based on the detecting window set by the detecting window setting unit and the body identifying information, to acquire a correlation degree value for evaluating the similar extent.

The judging unit judges the correlation degree according to a specified judging value (such as the value correspondingly prestored with the body identifying information). For example, when the correlation degree value reflecting the similar extent between the body identifying information and the template image exceeds the judging value, the frame is determined to be one frame including the specified body thermal image, that is, the specified body thermal image is detected, thus to acquire the detecting result. In the embodiment, the specified judging value is prestored in the table in FIG. 3 in the flash memory 3. However, users may set the judging value.

In detail, the detection of the detecting part 8 may be based on template matching, and the detecting part 8 may calculate and compare the correlation degree based on the thermal imaging data in the detecting window and the template image. For example, the detecting unit may calculate a sum of difference values of pixels at the corresponding positions in the image data of the infrared thermal image in the detecting window and in the image data of the reference image as the template, and the smaller the calculated sum of the difference values is, the higher the correlation degree is. When the calculated value is smaller than or equal to a specified judging value, it is determined that the specified body thermal image is detected. When the calculated value is greater than the specified judging value, it is determined that the specified body thermal image is not detected.

Further, the detection may be based on the matching of the characteristic extracted from the template image. The correlation degree may be determined according to the correlation degree between the template image and the characteristic of the thermal imaging data in the detecting window. For example, when the correlation degree between the ratio of the specified pixels extracted from the detecting window in the infrared thermal image and the ratio of the specified pixels in the template image is greater than the specified judging value, it is determined that the specified body thermal image is detected. Different methods for calculating the correlation degree may be used, and the processing mentioned here is just examples.

The detection of the detecting part 8 may be based on the characteristics (the body identifying information) described by parameters. The detecting part 8 performs specified calculation to acquire the characteristic of the thermal imaging data in the detecting window and compares the characteristic and the body identifying information (such as points, lines, or planes) described by the parameters, thus to acquire the judging result according to the specified judging value. For example, the characteristic is a pixel ratio of specified pixel values. The detecting unit calculates the pixel ratio of the specified pixel values in the thermal imaging data and compares the pixel ratio and the characteristic. When the comparison conforms to the specified judging value, it is determined that the specified body thermal image is detected.

The control part 11 controls the whole action of the thermal imaging device 100, and the flash memory 3 stores control programs and different kinds of data used in different control. The control part 11 may be realized through a CPU, an MPU, a SOC, or a programmable FPGA.

The control part 11 includes the reference image designating part 11A for designating the constituted data of the reference image that is displayed with the infrared thermal image together. For example, based on the constituted data of the reference image related to the body information stored in the storage medium, according to the body information selected by the users, the constituted data of the reference image related to the body information is designated. In addition, according to the default configuration of the thermal imaging device 100, the constituted data of the reference image is designated, such as the constituted data of the specified detecting area.

In addition, the control part 11 includes the position setting part 11B for setting the position parameter (a position, a dimension, or a rotating angle) of the reference image located in the display part. Preferably, the position setting part 11B is used for setting the position parameter of the reference image located in the infrared thermal image. For example, according to a specified self-adaptive display area in the infrared thermal image and a position parameter for maximum centered display of the calculated reference image in the self-adaptive area, the position parameter of the reference image located in the infrared thermal image is set. For example, according to the parameters (such as reflecting the position parameter in the infrared thermal image) attached by the reference image, the position parameter of the reference image located in the infrared thermal image may be set. Otherwise, according to the configuration (centered, an original dimension) of the thermal imaging device 100, the position parameter of the reference image located in the infrared thermal image may be set. Otherwise, the position parameter may be set according to the position parameter input by a user.

In addition, the control part 11 includes an informing part 11C. When the detecting part 8 detects the specified body thermal image, the inform control is performed. Based on the control of the informing part 11C, the display part may change the display content (for example, displaying the reference image with different effects, displaying an identification with different effects, displaying different indicating information, displaying the infrared thermal images with different effects, such as the infrared thermal image with the changed pseudo-color, the display of the reference image or not, the display of the identification or not, the display of the indicating information or not, or a combination thereof), a vibrating part in the thermal imaging device 100 may vibrate, light of an indicator light may be changed, sound of a sound part may be change, analysis of the analysis part (such as allowing the display part to display an analysis result) may be performed, diagnosis of the diagnosis part (such as allowing the display part to display an diagnosis result) may be performed, or a combination thereof may be performed, as long as the informing mode can be sensed by users.

The display controlling part 9 is used for displaying the image data stored in the temporary storage part 2 on the display part 10. For example, in a standby photographing mode, the infrared thermal images generated by the thermal imaging data frames acquired by photographing are continuously displayed. In a reference mode, the infrared thermal image (may be a dynamic infrared thermal image or a static infrared thermal image) and the reference image are displayed together. In a replay mode, the infrared thermal image read and expanded from the storage card 6 is displayed. In addition, different setting information may be displayed. In detail, the display controlling part 9 includes a VRAM, a VRAM control unit, and a signal generating unit (not shown). Further, under the control of the control part 10, the signal generating unit regularly reads the image data (the image data read from the temporary storage part 2 and stored in the VRAM) from the VRAM, and generates video signals to be displayed on the display part 10. In the thermal imaging device 100, the display part 10 may be a liquid display device. However, the invention is not limited thereto. The display part 10 may further be other display devices connected with the thermal imaging device 100, and the thermal imaging device 100 may not include the display part in itself. At that moment, the display controlling part 9 (or further including the communication I/F 4) may be an example of an output part of the infrared thermal image reflecting the reference image.

In addition, in the embodiment, based on the control of the informing part, the display part 10 is used for performing informing when the body thermal image matching the body identifying information is detected. For example, characters and images may be used for warning, such as twinkly displaying the reference image, displaying the reference image with changed colors, or displaying the changed infrared thermal image.

The operation part 12 is used for a user to perform operation such as indicating operation or inputting setting information. The control part 11 executes the corresponding program according to an operation signal of the operation part 12. As shown in FIG. 2, the operation part 12 may include a record key 1, a focusing key 2, an enter key 3, a replay key 4, a menu key 5, and a direction key 6. In addition, a touch screen 7 or a phonic part (not shown) may be used for realizing related operation.

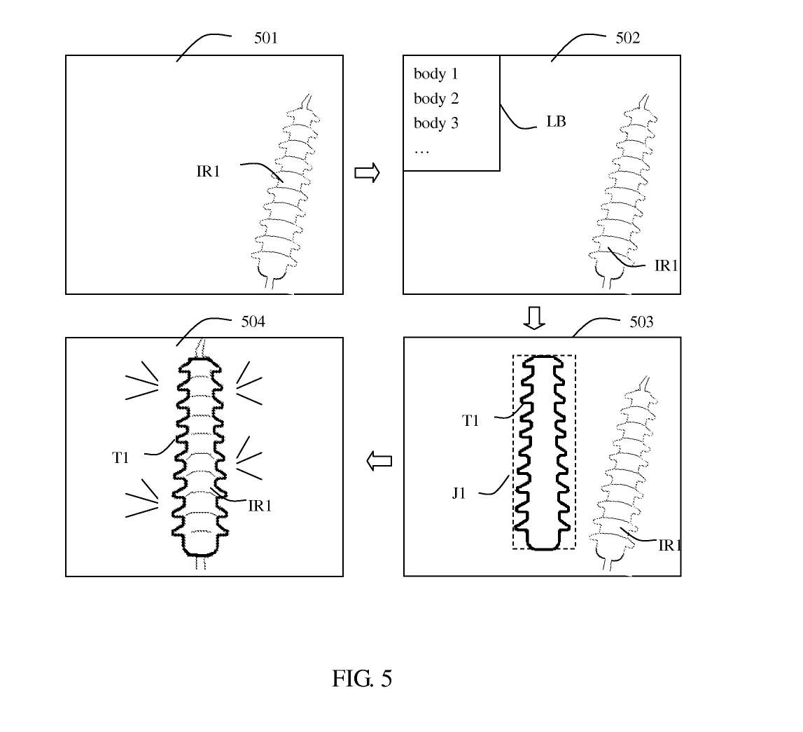

Referring to FIG. 4, the control flows of the reference mode of the thermal imaging device 100 are described. Referring to FIG. 5, the changes of the display interface during photographing are described. The applied scene may be that a user may photograph the bodies in a substation via a handheld thermal imaging device 100. Based on the control programs and different data used in each control stored in the flash memory 3, the control part 11 controls the whole action of the thermal imaging device 100 and execution of multiple mode processing. When the power is on, the interior circuits of the control part 11 are initialized, and then a standby photographing mode is entered, that is, the photographing part 1 acquires thermal imaging data frames, the image processing part 7 performs specified processing for the thermal imaging data frames acquired by the photographing part 1 to acquire the image data of the infrared thermal image that is to be stored in the temporary storage part 2, and the display part 10 continuously displays the infrared thermal image in a dynamic image mode. In the state, the control part 10 continuously monitors whether other modes are switched according to the predetermined operation or shutdown operation is performed. If yes, corresponding processing control is performed. The reference mode includes the following control steps.

In step A01, the control part 11 continuously monitors if a user selects the reference mode.

In the standby photographing mode, the display part 10 displays the dynamic infrared thermal image, and the infrared thermal image as shown in a display interface 501 in FIG. 5 may be acquired according to the photographing angle and distance at that moment. In the past, the morphological character of a body thermal image IR1 and the imaging position, dimension, and angle of the thermal image in the infrared thermal image confuse the user. To ensure the photographing quality, the reference mode is selected via the predetermined operation of the operation part 12. When the control part 11 detects that the user selects the reference mode (the step A01 is yes), the reference mode is performed.

In step A02, then the reference image designating part 11A designates the constituted data of the reference image. For example, based on the table in FIG. 3 stored in the flash memory 3, the control part 11 allows the body indicating information generated by the body information to be displayed on the display part 10, as shown in 502 in FIG. 5. When a user selects a “body 1” displayed on the display part 10 via the operation part 12 according to the “body 1” at the scene, according to the selection of the user, the reference image designating part 11A determines that the constituted data 301 is used for generating a reference image T1, and the constituted data 301 is read from the flash memory 3 and transferred to the temporary storage part 2.

In step A03, the position setting part 11B sets the position parameter (a position and a dimension) of the reference image T1 located in the infrared thermal image. For example, according to the position parameter attached by the constituted data 301, the position parameter of the reference image T1 located in the infrared thermal image is set. In addition, the position parameter of the reference image T1 located in the infrared thermal image may be determined according to a specified self-adaptive display area or the position parameter designated by the user.

In step A04, the thermal imaging data frame is acquired, and the thermal imaging data frame acquired by the photographing part 1 is transferred to the temporary storage part 2.

In step A05, the display controlling part 9 controls the display part 10 to display the reference image and the infrared thermal image together.

In detail, the image processing part 7 performs specified processing such as pseudo-color conversion for the acquired thermal imaging data frame, to acquire the image data of the infrared thermal image, and the synthesizing part 7A synthesizes (overlap) the image data of the reference image T1 acquired by the determined constituted data according to the set specified dimension and the image data of the generated infrared thermal image according to the set specified position. The synthesized image data is stored to the temporary storage part 2. Then, the display controlling part 9 allows the synthesized image to be displayed on the display part 10, as shown in a display interface 503 in FIG. 5. There is difference of the position and dimension between the body thermal image IR1 and the contour image T1. The users can photograph the body thermal image IR1 according to the reference image. If the specified body thermal image is not detected in the subsequent process, the reference image may be continuously synthesized with the newly acquired thermal imaging data frame, thus to continuously display the dynamic synthesized image.

In step A06, the character registering unit registers the reference image T1 as a matched template image.

Then, in step A07, the thermal imaging data frame instantly photographed by the photographing part 1 stored in the temporary storage part 2 is read. The detecting window setting unit sets a detecting window J1 (J1 shown in 503, which may be shown or not) according to the position parameter of the reference image T1 located in the infrared thermal image. The detecting window may be a bounding rectangle of the reference image T1.

In step A08, the calculation of the correlation degree is performed.

The detecting part 8 extracts the image data in the detecting window J1 to match the template and calculates the correlation degree therebetween, based on the detecting window J1 set by the detecting window setting part and the template (the reference image T1) registered by the character registering unit.

In detail, the detecting part 8 may perform the following processing to detect if there is the thermal imaging data of the specified body matching the reference image T1 in the thermal imaging data frame. First, the detecting part 8 extracts the thermal imaging data in the detecting window and performs binaryzation for the read thermal imaging data in the detecting window according to a specified threshold of the AD value. Then, a connected image of the connected pixels with the specified pixel value (1 or 0) is extracted from the binaryzation image. Then, if the size of the connected image is in a predetermined range is determined. If the size of the connected image is in the predetermined range, the matching processing is performed between the extracted connected image and the registered template (the reference image T1), for example, calculating the sum of the ratio of the overlapping area therebetween in the respective total area, thereby acquiring the value of the correlation degree between the extracted connected image and the reference image T1.

Further, in step A09, if the correlation degree value is greater than a specified judging value, the detecting part 8 determines that the specified body thermal image is detected. If the specified body thermal image matching the reference image T1 is not detected, return to the step A04, and in the step A05, the reference image is displayed with the infrared thermal image generated by the newly acquired thermal imaging data frame, or enter into step A11 and return to the step A04 without exiting. In the embodiment, the users change the photographing position and adjust the photographing distance, imaging position, and angle between the optical part of the thermal imaging device 100 and the “body 1” according to the reference image T1, as far as possible, allowing that the body thermal image IR10 and the reference image T1 in a display interface 504 in FIG. 5 are in a matching state of the imaging position, size, shape in visual. With the adjusting operation of the users, in the step A08, the newly acquired thermal imaging data frame is detected, and when the detected correlation degree is greater than or equal to the specified adjusting value in the step A09, enter into step A10.

The detecting part 8 may detect the continuously acquired thermal imaging data frame in turns or detect the thermal imaging data frame read from the specified interval, based on the thermal imaging data frames continuously acquired by the acquiring part, may perform lessening processing before detecting the image data in the read thermal imaging data frame or in the detecting window, or may perform thinning processing before detecting the image data in the read thermal imaging data frame or in the detecting window, thereby reducing processing load followed by the detection.

In step A10, the control part 11 controls the display part 10 to inform the users by one or several of the following modes.

For example, the informing may be realized through changing a transparency ratio, a color, a size of the reference image, allowing the reference image to twinkle (as shown in 504 in FIG. 5), and changing the constituted data of the reference image. In addition, the informing may be given through character indication, frozen displayed images, and the display of the specified image frame (such as the infrared thermal image acquired by the thermal imaging data frame through which the specified body thermal image is detected) at other position on the display part 10. The informing may continue specified time, for example, the reference image may be continuously twinkled for one second and may accompany color changes. Obviously, when the informing mode is to change the transparency ratio, color, dimension, twinkle of the reference image, the newly acquired thermal imaging data frame in the informing period may generate the infrared thermal image with the reference image according to the transparency ratio, color, dimension, twinkle of the changed reference image.

In step A11, whether the reference mode is exited is determined. If yes, end the reference mode. If no, return to the step A04 and repeat the above processing. Thus, for the continuously photographed thermal imaging data frame, when the specified body thermal image is detected, the user may be informed continuously, without subjectively judging the similar extent between the body thermal image and the reference image, thereby reducing the photographing workload.

According to the above, in the embodiment, since the reference image with the specified position and dimension and reflecting the specified morphological character of the body is displayed, the visual reference is provided for the morphological character of the body thermal image and the imaging position, size, and angle of the thermal image in the infrared thermal image. As the informing process is performed after the specified body thermal image is detected, the photographing difficulty and strength of the users may be greatly reduced.

Further, although the detecting window is set according to the position parameter of the reference image set by the position setting part to reduce the calculation workload, the multiple detecting windows may also be set.

### Embodiment Two

The difference between the first embodiment and the second embodiment is that the reference image is an image representing a detecting area (one or more detecting windows may be set in the detecting area) in the second embodiment. Further, the detection in the second embodiment is different from that in the first embodiment, and in the second embodiment the specified body thermal image is detected by comparing the body thermal image and the characteristic (the body identifying information).

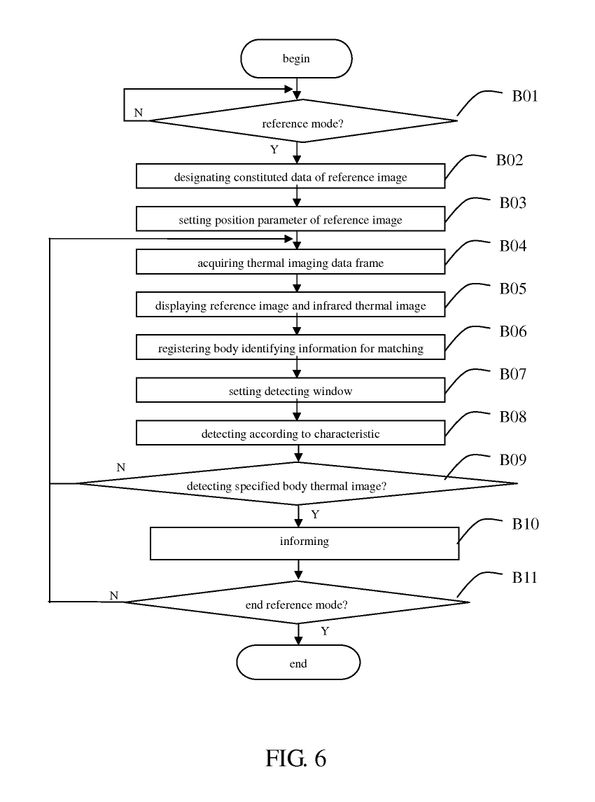

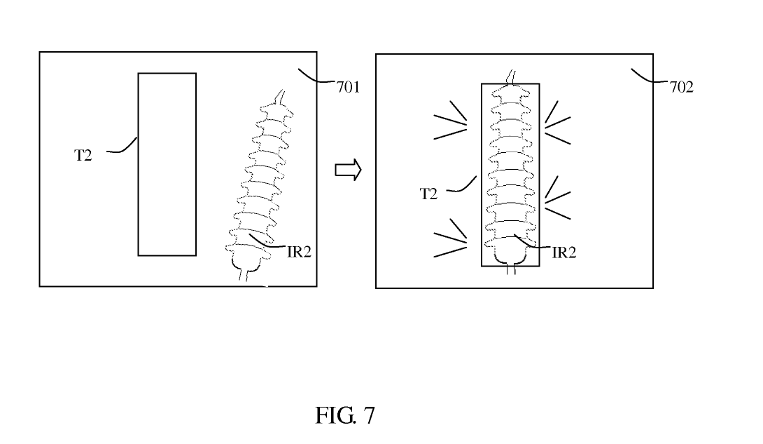

Referring to FIG. 6, the control flows of the reference mode of the thermal imaging device 100 in the second embodiment are described. Referring to FIG. 7, the changes of the display interface during photographing are described.

In step B01, when the control part 11 detects that a user selects the reference mode (yes in the step B01), the reference mode is entered.

In steps B02 to B03, in the embodiment, supposing that a body 2 is photographed, according to the selection of the user, the reference image designating part 11A designates “constituted data 2” (representing the constituted data of the detecting area and for acquiring a reference image T2) of the reference image. Then, the position setting part 11B sets the position parameter of the reference image T2 located in the infrared thermal image.

In step B04, then, the control part 11 controls to transfer the thermal imaging data frame acquired by the photographing part 1 to the temporary storage part 2, and indicates that the thermal imaging data frame can be read.

In step B05, the display controlling part 9 allows the reference image (a rectangular box T2) representing the detecting area to be overlapped and displayed on the infrared thermal image generated by the read thermal imaging data frame. The user may adjust the imaging position parameter of a body thermal image IR2 according to the rectangular box T2, as shown in a display interface 701 in FIG. 7.

Then, in step B06, the character registering unit 8 registers the characteristic 302 related to the body information of the “body 2” selected in the step B02 as the body identifying information for the subsequent calculation of the correlation degree. In the embodiment, the characteristic 302 respects a ratio of the pixel with the specified pixel value in all pixels of the specified detecting window (such as the rectangular box T2).

Then, in step B07, the detecting window setting unit sets the detecting window. In the embodiment, according to the position parameter of the rectangular box T2, the detecting window in the infrared thermal image is set.

Then, in step B08, the calculation of the correlation degree is performed.

In detail, the detecting part 8 may perform the following processing to detect the correlation degree between the body thermal image in the infrared thermal image and the characteristic. The detecting part 8 extracts the thermal imaging data located in the detecting window and generates a ratio of the specified pixel (such as the specified AD value) and the all pixels in the detecting window. In step B09, if the acquired ratio conforms to a predetermined ratio range (a specified judging value) of the characteristic, it is determined that the body thermal image is detected. The above processing is just an example, and different methods for extracting and determining the characteristic may be used.

If not conformed, it is determined that the thermal image of specified body is not detected. Return to the step B04 and repeat the subsequent processing, or enter into step B11 and return to the step B04 if not exited. The users change the photographing position and adjust the photographing distance, imaging position, and angle between the optical part of the thermal imaging device 100 and the “body 2” according to the rectangular box T2, as far as possible, allowing that the thermal image IR2 of the body and the rectangular box T2 in a display interface 702 in FIG. 7 are in a similar state of the imaging position, size, shape in visual. With the adjusting operation of the users, the newly acquired thermal imaging data frame is detected, and when the detected correlation degree with the characteristic conforms to the specified judging value, enter into step B10.

In step B10, the informing part 11C performs informing control, such as allowing the reference image T2 to be twinkled.

In step B11, whether the reference mode is exited is determined. If yes, end the reference mode. If no, return to the step B04 and repeat the above processing.

According to the above, in the embodiment, since the reference image representing the detecting area is displayed, the visual reference is provided for photographing the morphological character of the body thermal image and the imaging position and size of the body thermal image in the infrared thermal image. The users may adjust the thermal imaging device 100 according to the reference image to photograph the body thermal image, to allowing the imaging position of the body thermal image and the reference image matched, and the informing processing is performed after the specified body thermal image is detected, thereby reducing the difficulty and strength of aiming and photographing, improving the detecting quality and speed, and facilitating the common users grasping the photographing skill.

The displayed reference image is not limited to the rectangular box representing the detecting area (or the detecting window), and may be a circle, a reference image with any shape corresponding to the detected thermal image, or a reference image corresponding to points or lines in the detecting area.

### Embodiment Three

The difference among the third embodiment, the first embodiment, and the second embodiment is that in the third embodiment, the area in the infrared thermal image is designated by a user via the operation part, and according to the area in the infrared thermal image designated by the user, the reference image and the template image data subsequently as the body identifying information is designated.

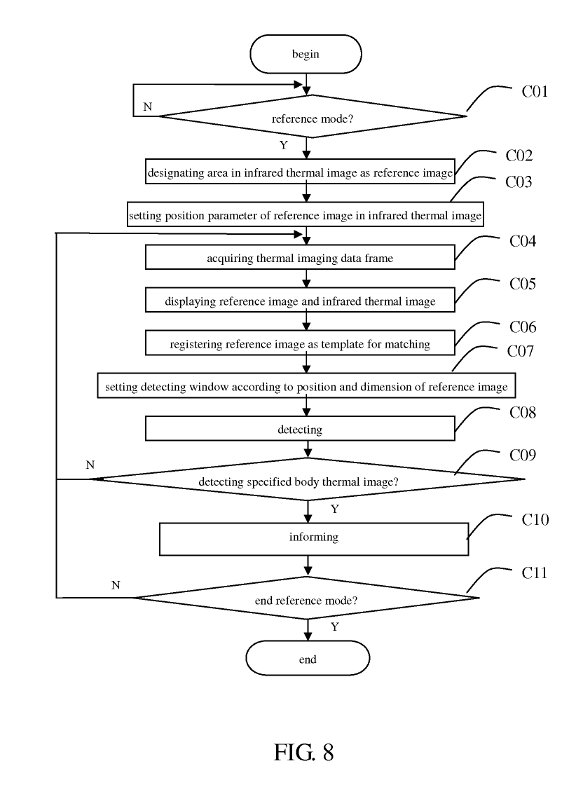

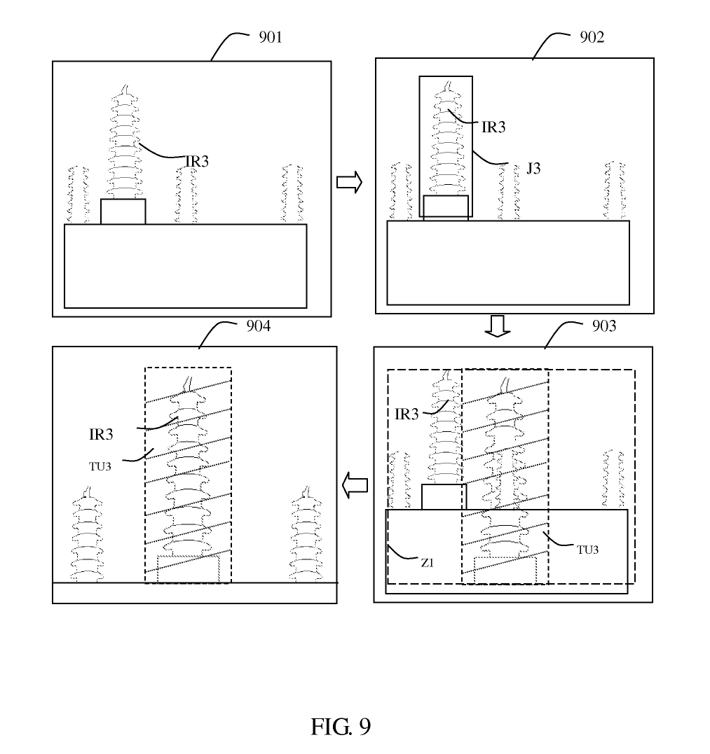

Referring to FIG. 8, the control flows of the reference mode of the thermal imaging device 100 in the third embodiment are described. Referring to FIG. 9, the changes of the display interface during photographing are described.

In step C01, the control part 11 continuously monitors if a user selects the reference mode.

In a standby photographing state, the display part 10 displays the dynamic infrared thermal image. According to the photographing angle and distance at that moment, the infrared thermal image as shown in a display interface 901 in FIG. 9 is acquired. When the control part 11 detects that the user selects the reference mode (yes in the step C01), the reference mode is entered.

In step C02, the control part 11 controls to display a cutting rectangular box J3. The user may adjust the photographing angle and distance of a body IR3 or adjust the cut area J3, thus to allow the body thermal image IR3 that is expected to generate the reference image to be located in the rectangular box J3, as shown in a display interface 902 in FIG. 9. Then, when the user presses the enter key, the reference image designating part 11A allows the cut image data in the area to be stored in a specified area of the temporary storage part, and designates the cut image data as the constituted data for generating the reference image TU3.

Further, in step C03, the position parameter of the reference image TU3 located in the infrared thermal image acquired according to the cut image data is set. In the embodiment, the position parameter (a position and a dimension) of the reference image TU3 is set according to a maximum centered display mode in a self-adaptive area Z1.

In step C04, the thermal imaging data frame is acquired, and the thermal imaging data frame acquired by the photographing part 1 is transferred to the temporary storage part 2.

In step C05, the image processing part 7 performs the specified pseudo-color processing for the acquired thermal imaging data frame, to acquire the image data of the infrared thermal image to be stored in the specified area of the temporary storage part 2. The synthesizing part 7A generates the reference image TU3 according to the cut image data and the set dimension, and synthesizes the reference image TU3 and the infrared thermal image according to the set position. Then, the display part 10 displays the image. As shown in a display interface 903 in FIG. 9, the reference image TU3 is overlapped and displayed on the infrared thermal image. The user may adjust the imaging position parameter of the photographed body thermal image according to the reference image TU3.

Then, in step C06, the character registering unit 8 registers the reference image TU3 as the body identifying information for subsequent correlation degree calculation.

Then, in step C07, the detecting window setting unit sets the detecting window. In the embodiment, according to the position parameter equal to that of the reference image TU3, the detecting window in the infrared thermal image is set.

In step C08, the detection of the correlation degree is performed. The detecting part 8 may perform the following processing to detect the correlation degree between the body thermal image in the infrared thermal image and the reference image TU3. The detecting part 8 reads the infrared thermal image from the specified area of the temporary storage part 2 stored in the step C05, and extracts the image data of the infrared thermal image in the detecting window. The detecting unit calculates a sum of difference values between pixels at corresponding positions in the image data of the infrared thermal image located in the detecting window and the reference image TU3 as the template, and the smaller the sum of the difference values is, the higher the correlation degree is. In step C09, when the acquired value conforms to a specified judging value, it is determined that the body thermal image is detected. In addition, the template image TU3 may be compared with the infrared thermal image in the detecting window via different characteristic extracting methods, and the above processing in the above embodiment is an just example.

If the specified body thermal image is not detected, return to the step C04, or enter into step C11, return to the step C04 if not exited and repeat the subsequent processing. In the embodiment, the user may change the photographing position and adjust the photographing distance, imaging position, and angle between the optical part of the thermal imaging device 100 and the “body 1”, as far as possible, allowing that the body thermal image IR3 and the reference image TU3 in a display interface 904 in FIG. 9 are in a similar state of the imaging position and size in visual. With the adjusting operation of the user, the infrared thermal image acquired according to the newly acquired thermal imaging data frame is detected, and when the detected correlation degree with the characteristic conforms to the specified range of the judging value, enter into step C10.

In step C10, the informing part performs informing control, such as emitting sound indication.

In step C11, whether the reference mode is exited is determined. If yes, end the reference mode. If no, return to the step C04 and repeat the above processing.

According to the above, in the embodiment, as the reference image and the body identifying information for detection is designated, the display of the reference image may be acquired and the detection may be performed without preparation beforehand, thereby facilitating operation and usage of the users.

In addition, when the thermal imaging device 100 includes other imaging devices or is connected with other imaging devices (such as a visible light camera not shown in FIG. 1), the constituted data of the reference image may be designated from the images captured by the other imaging devices.

In addition, a processing object may be selected from the storage medium. For example, the reference image may be designated and generated from the prestored infrared thermal images or visible light images read from the storage card 8.

Further, in the embodiment, although the reference image is used as a template at the same time, the template different from the reference image may also be set. For example, parts of the reference image may be as the template.

### Embodiment Four

The difference among the fourth embodiment, the first embodiment, the second embodiment, and the third embodiment is that in the fourth embodiment, the detecting part 8 detects the correlation degree between the thermal image and the body identifying information via multiple detecting windows in the thermal imaging data frame. Since the detecting range in the thermal imaging data frame increases, the operation of the users during photographing is easier. Further, the detecting part 8 is used for detecting specified information of the specified body thermal image in the thermal imaging data frame based on the acquired thermal imaging data frame. The informing part 11C controls to acquire the identification and/or the reference image reflecting the same or different morphological effects according to the specified information acquired by the detecting part 8. The specified information at least includes a position, a dimension, an inclined angle, a correlation degree value of the specified body thermal image, or a combination thereof.

Since the factors such as the photographing distance are depended, the dimension of the body thermal image is not a constant, and the imaging dimension may be referred by the reference image. For example, the detecting window may have the same position parameter with the reference image, and the judging value for determining if the specified body thermal image is detected may be given a greater range, thereby reducing detecting accuracy and detecting the specified body thermal image quickly, which may not be applied on the condition that there is limitation for the photographing distance.

The correlation degree between the thermal imaging data in the multiple detecting windows and the body identifying information may be detected by increasing the quantity of the detecting window. When there are multiple detecting windows, the detected maximum correlation degree value may be as the correlation degree value of the thermal imaging data frame. Thus, the operation of the users during photographing is easier. In addition, according to the specified position between the detecting windows, a plurality of thermal images of the specified bodies (such as different bodies with the same model) may be detected.

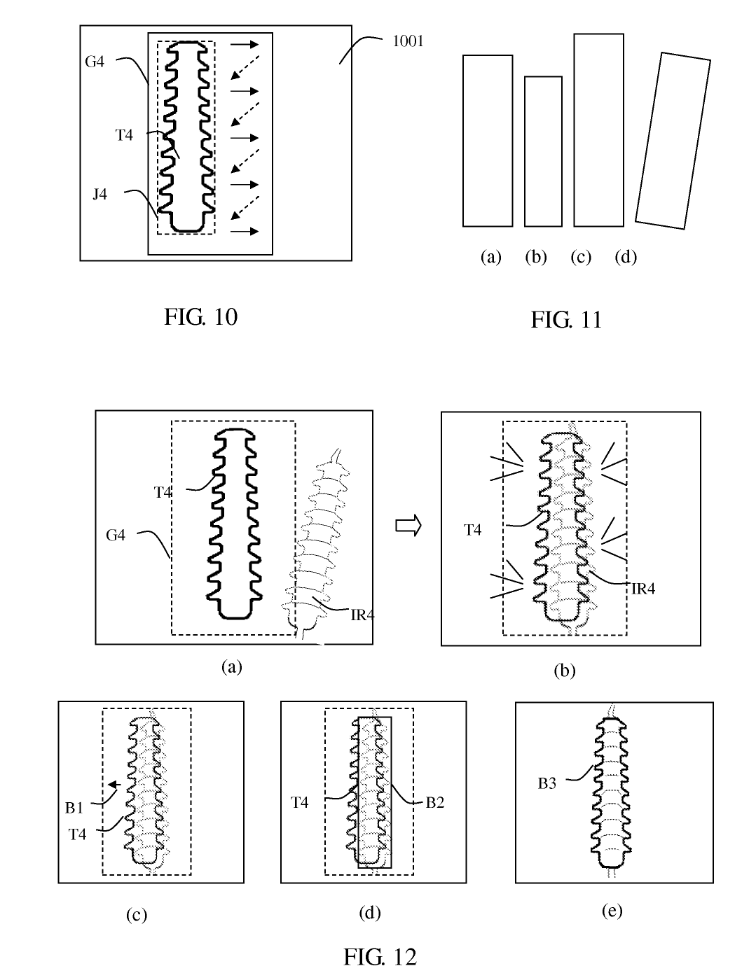

The detecting window setting unit of the detecting part 8 is used for setting the detecting window. For example, according to the detecting area (such as G4 in FIG. 10) in a certain range, a plurality of the detecting windows are set in the detecting area G4, the detecting windows may be the detecting windows with different dimensions, and may be the inclined detecting window. The dimension and inclination of the detecting window may be preset according to the requirement for the photographing quality. In FIG. 11, FIG. 11(a) shows a standard detecting window, FIG. 11(b) shows a detecting window with a reduced dimension, FIG. 11(c) shows a detecting window with an enlarged dimension, and FIG. 11(d) shows a detecting window inclined according to a specified angle. To be equal to the dimension of the detecting window, the template image may be used in a reduced, enlarged or inclined state, or the template image with the dimension equal to the window dimension may be prepared and stored for use. In addition, the thermal imaging data in the detecting window may be used in a reduced, enlarged, or inclined state, to correspond to the template image.

The detecting area may be set according to photographing customs of the users, may be prestored and related to the body information, may be generated according to the position previously set, or may be a range of the thermal imaging data frame. The multiple detecting windows may be set according to the position and dimension designated by the users. In addition, the multiple detecting windows are not necessary, and only one detecting window may be set.

In the infrared detection applied field, there are a large amount of devices with different names and similar shapes in a substation. To avoid misleading the users and incorrectly photographing, the detecting area may be set preferably. As the detecting area is overlapped and displayed on the infrared thermal image, the users may understand the approximate position and dimension of the body thermal image to be photographed, thereby accelerating the detecting speed. However, the detecting area may not be shown.

The detecting unit of the detecting part 8 reads the thermal imaging data frame from the temporary storage part 2, and acquires the correlation degree value between the thermal imaging data in the detecting window set by the detecting window setting unit in the read thermal imaging data frame and the body identifying information.

In an example of detection for the multiple detecting windows, in FIG. 10, the detecting part 8 detects in the specified detecting area G4 of the thermal imaging data frame 1001 by moving a window J4 from the left-upper corner to the right-lower corner, cuts the thermal imaging data in the window, and detects the correlation degree of the thermal imaging data and a template image T4. In detail, the window J4 gradually moves from the left end to the right end through a specified value as the window displacement (such as one pixel), is set to return to the left end and move downwards when achieving the right end, and moves rightwards gradually afterwards. To accurately detect the body, a changing range of the size, displacement, and rotating angle of the window is defined in advance. For example, the changing range of the window size may be from 150×50 pixels to 120×40 pixels, the changing range of the window displacement may be from 10 pixels to one pixel, and the changing range of the rotating angle of the window may be 0° to 10° based on a center point. The detecting part 8 gradually changes the window size at each time of five pixels, changes the window displacement at each time of one pixel, and changes the rotating angle of the window at each time of 2°. At that moment, the detecting part 8 calculates the correlation degree of the template image T4 and the thermal imaging data frame 1001, and selects the correlation degree value acquired from the detecting window with the maximum correlation degree value as the correlation degree value corresponding to the thermal imaging data frame 1001 after the detection of all detecting windows. The above processing method is just examples, and different methods may be used for calculating the correlation degree of the thermal imaging data frame based on the body identifying information.

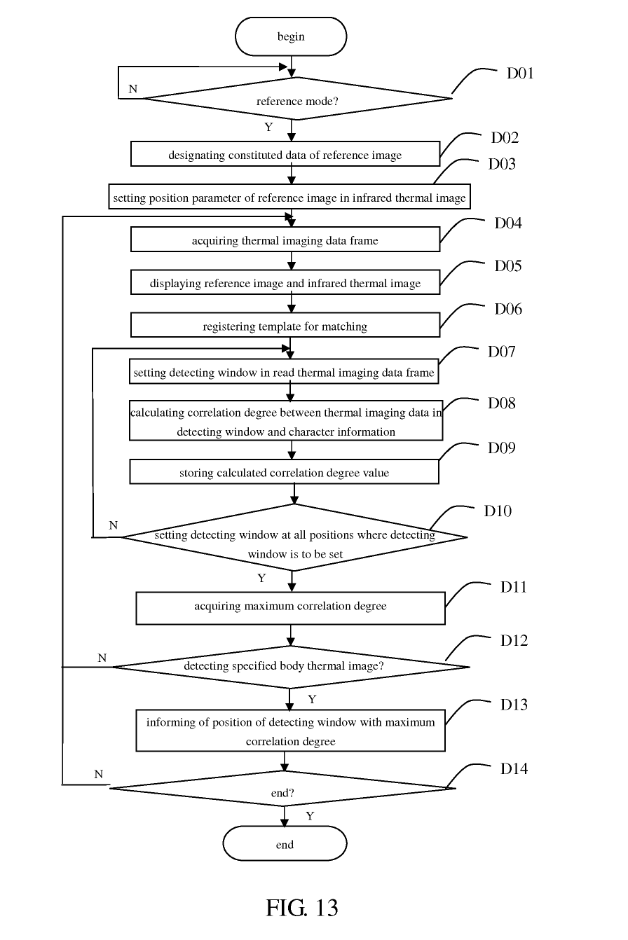

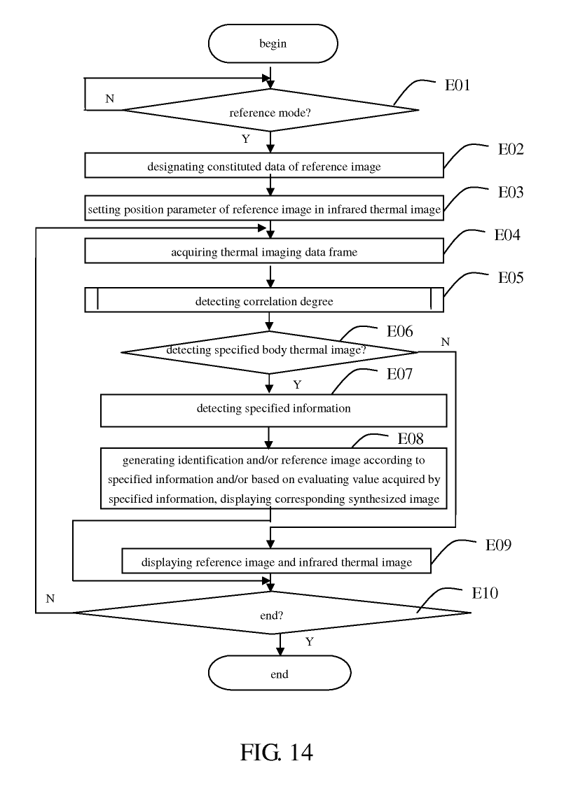

Referring to FIG. 12, the changes of the display interface during photographing are described. Referring to FIG. 13, the control flows of the reference mode of the thermal imaging device 100 in the fourth embodiment are described.

Step D01 to step D05 are similar to the steps A01 to A05 in the first embodiment. Therefore, the repeated description is removed.

In step D06, the character registering unit registers the body identifying information (the contour image T4). Then, in step D07, the thermal imaging data frame is read from the temporary storage part 2. The detecting window setting unit sets the rectangular detecting area G4 by enlarging a specified scale based on a center point of the reference image T4 according to the position and dimension of the reference image T4 located in the infrared thermal image. Further, a detecting window J4 with the same dimension of the bounding rectangle of the reference image T4 is set at the left-upper corner of the detecting area G4. In FIG. 12(a), the detecting area G4 and the contour image T4 are overlapped on the infrared thermal image together as the reference image. Thus, the users can understand the approximate position and dimension of the body thermal image to be photographed, thereby facilitating photographing. However, the detecting area G4 may not be shown.

Then, in step D08, the detection is performed, and the correlation degree of the thermal imaging data of the detecting window and the template image T4 is calculated. In step D09, the detected correlation degree value and the position parameter of the corresponding detecting window are stored to the specified area of the temporary storage part 2.

In step D10, the detecting part 8 determines if the correlation degree related to all detecting windows is calculated when the detecting window is set in the thermal imaging data frame. If there is the surplus area without calculating the correlation degree (no in the step D10), return to the step D07. The detecting window setting unit predetermines pixels of the position displace of the detecting window on the predetermined direction, the position is set as the following position of the detecting window, and the following processing is repeated.

If the calculation of the correlation degree is performed for all detecting windows set in the thermal imaging data frame (yes in the step D10), in step D11, the maximum correlation degree value is selected. In step D12, the selected value is compared with the specified judging value. If the specified body thermal image is not detected in the step D12, return to the step D04 or enter into step D14 and return to the step D04 if not exited, and the following processing is repeated. If the specified body thermal image is detected, in step D13, informing is performed.

In step D13, the informing control is performed, such as changing colors, vibrating, changing sound or light as shown in FIG. 12(b). Further, the position of the detected specified body thermal image with the maximum correlation degree may be informed via other modes.

In FIG. 12(c), one example of the identification is shown. According to the difference of the position, dimension, and rotating angle between the detecting window (or the body thermal image therein) and the reference image T4, the corresponding auxiliary identification B1 may be generated for indicating adjustment. At that moment, the color of the auxiliary identification such as an arrow may be determined according to the correlation degree.

In FIG. 12(d), another example of the identification is shown. According to the position of the detected body thermal image IR4 (such as the position of the detecting window), the position identification B2 (may be other identification such as points, lines, or planes) may be generated.

In FIG. 12(e), another example of the identification is shown. According to the position of the detected body thermal image IR4, the position identification B3 is generated (such as according to the constituted data of the reference image T4, or other identification i.e. points, lines, or planes), and the reference image T4 may not be shown, thereby generating the similar absorbing effect.

The identification with different morphological effects is shown in FIG. 12(c), (d), (e). The informing part 11C controls to generate the reference image and/or the identification reflecting the same or different morphological effects according to the specified information acquired by the detecting part 8. The different morphological effects of the reference image at least include the difference of colors, line types, thickness or thinness, transparency ratios, shapes, contents (such as including different colors), twinkling states, luminance, constituted data, positions, dimensions, rotating angles, or indicating information. The different morphological effects of the identification at least include the difference of colors, line types, thickness or thinness, transparency ratios, shapes, twinkling states, luminance, constituted data, positions, dimensions, rotating angles, or indicating information. The reference image is provided for the users to photograph the body, and the identification is mainly used for indicating the users to pay attention to information or states related to detection. Usually the reference image needs to be displayed before detection, and the identification may be displayed based on the detecting result.

In detail, in one preferred embodiment, the image processing part 7 includes an identification generating unit (not shown). Based on the control of the informing part 11C, according to the specified information (the parameter such as the position, dimension, or rotating angle) acquired by the detecting part 8, the identification is generated, and the image processing part 7 generates the infrared thermal image with the identification.

In step D14, if exited is determined. If no, return to the step D04.

In addition, when the frame similar to the template image T4 is found from the thermal imaging data frames, the detection described above may also be performed for the detecting window acquired after the detecting window J4 is enlarged, reduced, or rotated along a specified angle.

According to the modification of the fourth embodiment, on some conditions, if the specified body thermal image is detected may be determined by the comparison between the correlation degree value and the judging value of the correlation degree, or may be determined by the comparing result between specified information and/or the evaluating value acquired by detection and the corresponding comparing value. The specified information may be the position, dimension, inclined angle, the correlation degree value of the body thermal image, or a combination thereof.

According to the above, in the embodiment, the effect of the first embodiment can be achieved. Further, since the detecting area including the multiple detecting windows is set, the visual aiming operation difficulty can be reduced, and the detecting accuracy of the body during detection and matching can be improved. The common users can easily grasp the photographing skill. Any product applying to the embodiment of the invention is not necessary to achieve all of the advantages at the same time.

### Embodiment Five

The difference among the fifth embodiment, the first embodiment, the second embodiment, the third embodiment, and the fourth embodiment is that in the fifth embodiment, the detecting part 8 is used for detecting the specified information of the specified body thermal image in the thermal imaging data frame based on the acquired thermal imaging data frame, and the informing part 11C controls to generate the identification reflecting the same or different morphological effects and the indicating information of different contents according to the specified information acquired by the detecting part 8. The specified information at least includes the position, dimension, inclined angle, analysis value, the value of the correlation degree of the specified body thermal image, or a combination thereof.

In the infrared detection field, since it is considered that the difference of the position, dimension, or inclined angle of the body thermal image in the infrared thermal image corresponds to the different photographing quality, the factors such as the position, dimension, and inclined angle of the body thermal image located in the thermal imaging data frame may be considered as the factors for generating the identification with the different morphological effects and/or the indicating information of different contents, thereby indicating the users to pay attention to the photographing quality.

Further, the detecting part 8 includes a functional unit for detecting an analysis value. The analysis value may be acquired after calculating the detected thermal imaging data frame or the detected body thermal image according to a specified algorithm, may be a temperature value acquired by calculating the thermal imaging data AD values in the detecting window, or may be a temperature comparing value in different analysis areas, such as temperature difference. The specified algorithm may be to calculate the maximum, minimum, or average temperature value in a specified analysis area. When there is the analysis value greater than the specified comparing value (such as a defected threshold) in the body thermal image, the body has defects, and the users need to pay more attention. At that moment, the specified identification or indicating information instantly arouses the attention of the users, providing important significance of the infrared detection. The analysis value is not limited to the temperature value, may be an AD value, a color value in the pseudo-color thermal image, a ratio of the specified pixel values, or a value acquired by calculating the above values according to a specified formula.

Thereby, when the detecting part 8 is configured to detect the multiple specified information of the body thermal image, the informing part 11C generates the identification and/or the indicating information and/or the reference image reflecting the same or different effects according to the specified information acquired by the detecting part 8.

According to a comparing table of the specified information, identification data, and the reference image, the corresponding identification and the reference image may be generated. For example, the different position, dimension, and rotating angle may correspond to the different transparency ratio and line type, the different analysis value may correspond to the different color, and the different correlation degree value may correspond to different shape, thereby acquiring the corresponding identification and the reference image.

For example, when the detecting part 8 detects that there is the analysis value of the AD value of the thermal image greater than a specified value in the body thermal image, the analysis value equal to or greater than the specified value corresponds to the red color, thereby displaying the reference image to be red, and the analysis value smaller than the specified value corresponds to the blue color, thereby displaying the reference image to be blue.

Further, a comprehensive evaluating value may be acquired according to the specified information. For example, the specified information in the detected information corresponds to different coefficients, and the evaluating value may be acquired by combining the coefficient and other specified information in the detected information. Otherwise, the evaluating value may be acquired by weighting according to the weighted values of different information. The final evaluating value may be acquired via different calculating modes.

Then, the identification may be generated according to a comparing table of the evaluating value and the identification data. The identification data includes the parameter or data for differentiating the identification according to the color, line-type, transparency ratio, twinkle, or different identification type (such as a square, a circle, or a contour) of the identification to which each interval corresponds.

For example, in FIG. 15, the detecting window is displayed as the identification. As the detecting window may reflect the general position and dimension, different window coefficients may be provided. In FIG. 15(a), the window coefficient of a detecting window J1 is 0.8. In FIG. 15(b), the window coefficient of a detecting window J1 is 0.95. The evaluating value is equal to the product of the correlation degree value and the window coefficient. Therefore, when the thermal imaging data with the same correlation degree is detected in two windows, the combination of the correlation degree value and the evaluating value of the detecting window J2 (supposing converting to 95%) may be greater than the combination of the correlation degree value and the evaluating value of the detecting window J1 (supposing converting to 80%). The identification with different morphological effects may be acquired according to the line type to which the evaluating value corresponds (95% corresponds to a full line, 80% corresponds to a dotted line).

In addition, the evaluating value acquired according to the part information in the detected specified information may be generated, and the identification may be generated according to a comparing table of the evaluating value, the specified information that is not used for generating the evaluating value, and the identification data.

Preferably, the comparing table of the specified information and/or the evaluating value acquired by the specified information, the identification data, the reference image, and the indicating information may be prepared according to different bodies, and the table may be correspondingly stored with the body information and the body identifying information in table three.

Referring to FIG. 14, the control flows of the detecting mode of the thermal imaging device 100 in the fifth embodiment are described.

Steps E01 to E03 are similar to the steps A01 to A03 in the first embodiment. Therefore, the description is omitted.

In step E04, the thermal imaging data frame is acquired, and the thermal imaging data frame acquired by the photographing part 1 is transferred to the temporary storage part 2.

In step E05, the thermal imaging data frame acquired by the photographing part 1 is read from the temporary storage part 2, and the detection is performed, which is similar to the steps D06 to D11 in the fourth embodiment. Therefore, the description is omitted.

In step E06, if the specified body thermal image is not detected, jump to step E09 and display the reference image and the infrared thermal image. When the specified body thermal image is detected in the step B06 (the correlation degree is greater than the specified judging value), enter into step E07.

In step E07, the detecting part 8 further detects the thermal imaging data frame in the detecting window in which the correlation degree is greater than the specified judging value, to acquire the specified information such as the analysis value. In addition, the more accurate parameter such as the position, dimension, or rotating angle of the body thermal image may be acquired according to the position parameter of the detecting window or the contour of the body extracted from the detecting window.

In step E08, the informing part 11C controls to generate the corresponding identification and indicating information according to the acquired specified information. Then, the image processing part 7 is controlled to synthesize such as overlap the generated identification and/or indicating information and the infrared thermal image acquired by the thermal imaging data frame and to display the synthesized image.

In addition, the identification or the reference image may not be shown, and the detected specified information and the evaluating value is converted to the indicating information such as characters, numbers, or letters which the users may understand easily for displaying. For example, the evaluating value may be converted to a percentage (the evaluating value is converted to the percentage) or other modes, such as directly displaying the calculated evaluating value. Otherwise, the different identification may be generated, and the indicating information of the evaluating value may be displayed. In FIG. 15, the displayed evaluating value in FIG. 15(a) is 80% (corresponding to the identification of the dotted line box J1), and the displayed evaluating value in FIG. 15(b) is 95% (corresponding to the identification of the full line box J2).

Further, the specified evaluating value or the detected specified information is informed in other ways. For example, when the detected analysis value is greater than the specified comparing value, the indicating light is twinkled. The informing mode may continue for specified time. The informing part may be a vibrating part, an indicating light (not shown), an analysis part (not shown), or a diagnosis part (not shown) in the thermal imaging device 100. Based on the control of the control part 11, when the specified thermal imaging data frame is detected, the indicating light may generate light changes, the vibrating device may generate vibration, the analysis part may perform analysis and display an analysis result, the diagnosis part may perform diagnosis and display a diagnosis result, or a combination of the above modes may be used for informing, as long as the users can be informed. Then, enter into step E10.

In step E10, whether the reference mode is exited is determined. If yes, end the reference mode. If no, return to the step E04, and repeat the above processing.

Thus, for the thermal imaging data frames acquired by continuous photographing, when the specified body thermal image is detected (for example, when the correlation degree of the thermal imaging data frame is greater than the specified judging value), the corresponding identification and indicating information may be generated according to the detected specified information, to inform the users continuously, as shown in FIG. 15. When the specified body thermal image is not detected, the original reference image and the infrared thermal image (not shown) are displayed. Further, the identification with different visual effects and the indicating information of different contents may be provided according to the detected specified information, thereby further reducing the photographing workload, avoiding photographing wrong parts, and indicating the specified detecting result.

According to the modification of the fifth embodiment, on some conditions, if the specified body thermal image is detected may be determined by the comparison between the value and judging value of the correlation degree, or may be determined by the comparing result between the specified information and/or evaluating value acquired by detection and the corresponding comparing value. In addition, the step E07 may be removed, and in the step E08 the informing may be performed according to the result of the detection of the specified body thermal image.

According to the above, in the embodiment, since the identification and/or indicating information is generated according to the position, dimension, inclined angle, analysis value, the value of the correlation degree of the specified body thermal image, or a combination thereof, the users can be instantly informed to pay attention to specified conditions, the visual aiming operation difficulty can be greatly reduced, the work strength of photographing can be greatly reduced, and the quality of the finally acquired thermal imaging data frame can be improved. The common users can easily grasp the photographing skill. Any product applying to the embodiment of the invention is not necessary to achieve all of the advantages at the same time. The difference with the first embodiment is that the value of the correlation degree to which the thermal imaging data frame corresponds is not limited to the value of the correlation degree acquired by selecting the detecting window with the maximum correlation degree in this embodiment.

### Embodiment Six

The difference among the sixth embodiment and the first to fifth embodiments is that in the sixth embodiment, the thermal imaging data frame is detected in a replay mode of the thermal imaging device 100. This embodiment is also applied to the detection for the infrared thermal image in a frozen state and the detection when a thermal image processing device (such as a computer) reads thermal imaging files.

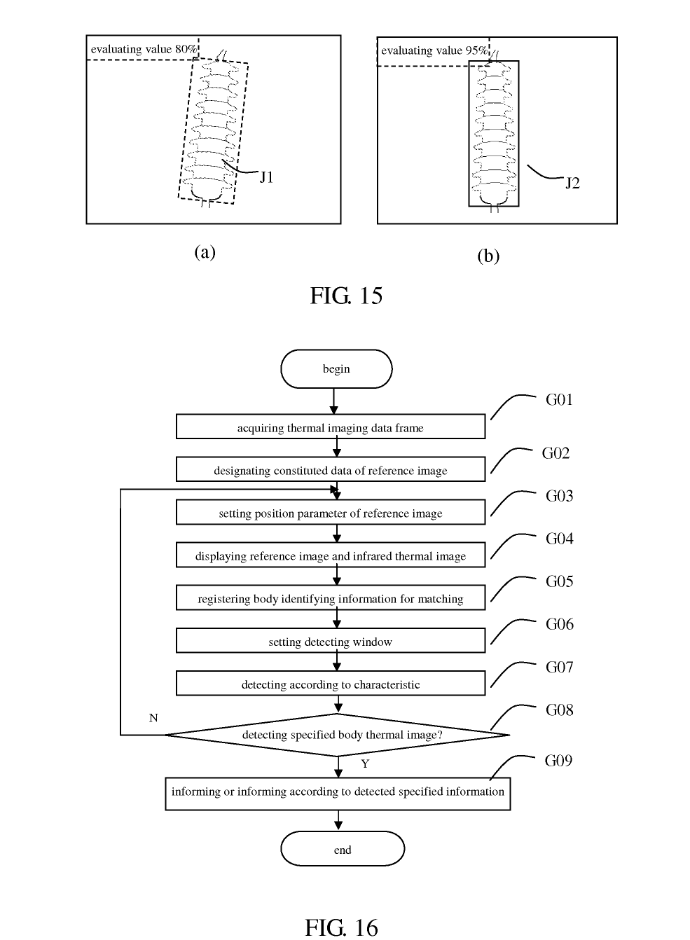

Referring to FIG. 16, the control flows of the reference mode of the thermal imaging device 100 in the sixth embodiment are described.

In step G01, the thermal imaging data frame is acquired. For example, according to operation of the users, the thermal imaging data frame to be detected is acquired by reading the thermal imaging file from the storage card 8.

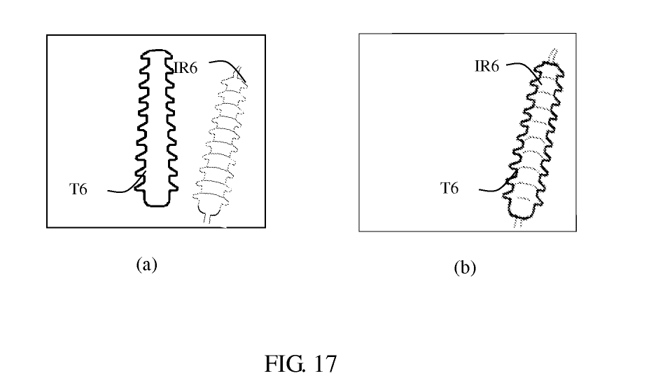

In step G02, the constituted data of the reference image is designated. Further, in step G03, the position parameter of the reference image is set. In step G04, the reference image and the infrared thermal image generated by the acquired thermal imaging data frame are displayed. At that moment, the display part 10 displays the interface as shown in FIG. 17(a).

In step G05, the body identifying information (such as the characteristic) for matching is registered.

In step G06, the detecting window is set. In the embodiment, the detecting window is set according to the position parameter of the reference image T6 in the infrared thermal image. For example, a bounding rectangle of the reference image T6 may be set as a detecting window.

In step G07, the detection is performed, further to acquire a correlation degree value of the thermal imaging data of the thermal imaging data frame in the detecting window.

In step G08, the specified judging value is compared with the correlation degree value of the thermal imaging data in the detecting window, to determine if the specified body thermal image is detected.

If no, return to the step G03. A user may adjust the position, dimension, and rotating angle of the contour image T1 to match a thermal image IR6 of the body in FIG. 17(a) via the operation part 11. The position setting part 11B changes at least one of the position, dimension, and rotating angle of the reference image in the infrared thermal image according to the adjusting indication of the user. Then, in the step G04, the changed reference image and the body thermal image are synthesized and displayed, reflecting the adjusting process of the user. Further, in the step G06, according to the position parameter of the reference image after changed, the detecting window is set, and the subsequent processes are repeated.

If yes, in step G09, informing is performed, such as changing the color of the reference image T6.

The reference image may be the reference image reflecting the morphological character of the body. Further, the reference image and the body identifying information may be acquired from a database of the body identifying information prestored in thermal imaging device 100, or may be temporarily set or designated by users.

According to the above, in the sixth embodiment, the infrared thermal image generated by the acquired thermal imaging data frame and the reference image are displayed together. Then, according to the adjusting of the user, the matched area is continuously detected, until the area matching the body identifying information is acquired, thereby capable of effectively acquiring the position parameter of the body thermal image in the infrared thermal image and reducing technical analysis and workload of the users. By changing the position parameter of the reference image, the detecting window is changed to perform the detection, which is also applicable to the detection for the dynamic thermal imaging data frame.

In the above embodiment, the correlation degree value is used for determining if the specified body is detected. However, the comparing result between the specified information and/or the evaluation value acquired by detection and the corresponding comparing value may also be used for determining if the specified body thermal image is detected.

The thermal imaging device 100 is described in the respect embodiment. This invention is not only applicable to the thermal imaging device with the photographing function such as different kinds of portable or on-line photographing thermal imaging devices, but is also applicable to different kinds of thermal image processing devices such as a thermal image processing device (such as a computer, a personal digital assistant, or a display device used in a set of a thermal imaging device with the photographing function) continuously receiving thermal images from outside and processing thermal images (such as acquiring the thermal imaging data frame according to the time sequence). The thermal image processing device may be a computer, which is wireless or wiredly connected with the thermal imaging device via a communication interface (one example of the acquiring part may be that the thermal image processing device is connected with an external device according to communication specification such as USB, 1394, or network), and continuously receives the thermal imaging data frame output by the connected thermal imaging device. The detection and informing modes are similar to that in the above embodiment, which is without description.

This invention is not limited to acquire the thermal imaging data frame by photographing or from outside, which may also be as one part or functional module in the thermal imaging device or the thermal image processing device, such as acquiring the thermal imaging data frame from other parts.

The informing may be performed when the specified body thermal image is detected or when the thermal imaging data frame of the body thermal image is detected. For example, the infrared thermal image acquired by the thermal imaging data frame for detecting the body thermal image and the generated identification with the specified effect and/or the reference image may be displayed together, or the infrared thermal image acquired by the newly acquired thermal imaging data frame in specified time and the identification and/or the reference image may be displayed. The informing mode may also be a communicating mode or a record mode. For example, the specified thermal imaging data frame, the information that the specified body thermal image is detected, a generated triggering signal, or a warning signal may be transmitted to other external devices or network destination via the communication I/F 4.

Further, the whole area of the body may be detected, and the multiple detecting windows composed by the multiple parts by dividing the body may be detected, thereby capable of achieving more accurate detection. During the detection for each part, the corresponding body identifying information (may be templates or characteristics) may be prepared. Otherwise, the detecting unit may acquire the judging result according to the body identifying information and the judging value to which the multiple body identifying information corresponds. For example, the final adjusting result may be acquired according to the weighting value of the multiple characteristics. Otherwise, the detecting unit may first calculate the comparing result between one of the characteristics and the thermal imaging data frame according to the multiple body identifying information, and calculate the comparing result between the next body identifying information and the thermal imaging data frame when the first comparing result is greater than a specified threshold. The final judging result is acquired according to the multiple comparisons. Different methods for detecting the specified body thermal image may be used, and the processing in the above embodiment is just examples.

The above embodiments are described according to a step sequence. However, there are different sequences in different embodiments, which is not limited to the above embodiments. When the control part 11 and the image processing part include multiple processors, some steps may be processed in parallel.

The storage medium storing the body identifying information may be a storage medium in the thermal imaging device 100, such as a non-volatile storage medium, i.e. the flash memory 3 or the storage card 6, or a volatile storage medium i.e. the temporary storage part 2, or may be other storage mediums wiredly or wirelessly connected with the thermal imaging device 100, such as other wiredly or wirelessly connected devices via the communication I/F 4, i.e. other storage devices, a storage medium in a thermal imaging device, a computer, or a network destination.

In one preferred embodiment, the body identifying information is related to the body information, and the different applicable body information may be prepared according to different applications. For example, in the electric power industry, the body information may be recognized information representing the identity of the body, such as the information representing the position, type, and phase of the body, or may be information representing the type of the body. Obviously, the body identifying information is not limited to be related to the body information.

In the invention, a computer (or a device such as a CPU, MPU) with the above functional system or device may be performed by the single program or the program record on the storage device, and the computer may read and run the program record on the storage device to achieve the above functions. Thereby, the program may be provided to the computer or the thermal imaging device via network or different types of record mediums (such as a computer readable medium) as the storage device.

This invention provides a computer program, and the digital signals composing the computer program are record on a readable record medium in a computer or a thermal imaging device, such as a hard disk, a memorizer. The following steps are performed after the program is executed.

A method for detecting thermal images in the invention includes a photographing step for continuously photographing to acquire the thermal imaging data frame, a display controlling step for controlling to display a dynamic infrared thermal image acquired by the thermal imaging data frame and a reference image, a detecting step for detecting if there is a specified body thermal image in the thermal imaging data frame based on the acquired thermal imaging data frame, and an informing step for performing the informing control when the specified body thermal image is detected in the detecting step.

This invention further provides a readable storage medium storing a computer program for exchanging digital data. The computer program allows the computer in the thermal imaging device to perform the following steps.

A method for detecting thermal images includes an acquiring step for continuously acquiring the thermal imaging data frame, a display controlling step for controlling to display a dynamic infrared thermal image acquired by the acquired thermal imaging data frame and a reference image, a detecting step for detecting if there is a specified body thermal image in the thermal imaging data frame based on the acquired thermal imaging data frame, and an informing step for performing informing control when the specified body thermal image is detected in the detecting step.

Although the function block in the figures may be realized via hardware, software, or a combination thereof, the function block may be not necessary to be realized in one-by-one mode. For example, one software or hardware unit may be used for realizing multiple function blocks, or multiple software or hardware units may be used for realizing one function block. In addition, the processing and control functions of parts or whole in the embodiments may be realized via a special-use circuit, a general processor, or a programmable FPGA.

In addition, in the embodiment, the electric power industry as the scene is taken for example, and different fields of the infrared detection are also applied. The above description is just detailed examples (embodiments) of the invention, and different examples and description do not limit the substantive contents of the invention. Further, different embodiments may be taken place and combined to form more embodiments. After reading the description, persons having ordinary skill in the art may make various modifications and changes without departing from the scope and spirit of the invention.

1-28. (canceled)

29. A device for detecting thermal images, comprising:
an acquiring part for continuously acquiring a thermal imaging data frame;
a display controlling part for controlling to display a reference image and a dynamic infrared thermal image acquired by the acquired thermal imaging data frame;
a detecting part for detecting if there is a specified body thermal image in the thermal imaging data frame based on the acquired thermal imaging data frame;
an informing part for performing informing control when the detecting part detects the specified body thermal image.

30. A device for detecting thermal images, comprising:
an acquiring part for acquiring a thermal imaging data frame;
a display controlling part for controlling to display an infrared thermal image acquired by the acquired thermal imaging data frame and a reference image located in the infrared thermal image;
a detecting part for detecting if there is a specified body thermal image in the thermal imaging data frame based on the thermal imaging data frame acquired by the acquiring part;
an informing part for performing informing control when the detecting part detects the specified body thermal image.

31. The device for detecting thermal images according to claim 29, wherein the informing part is used for controlling to generate a display change, to generate a sound reminder, to allow an indicator lamp to be twinkled, to generate vibration, to perform analysis, to perform diagnosis, to perform communication, or a combination thereof.

32. The device for detecting thermal images according to claim 29, wherein the informing part is used for controlling to generate a display change between a display interface after the specified body thermal image is detected and the display interface before the specified body thermal image is detected, and the display change comprises the display of the reference image with different effects or without the reference image, the display of an identification with different effects or without the identification, the display of different indicating information or without the indicating information, the display of the infrared thermal image with different effects, or a combination thereof.

33. The device for detecting thermal images according to claim 32, wherein the different effects of the reference image at least comprise the difference of a color, a line type, thickness or thinness, a transparency ratio, a shape, a content, a twinkling state, luminance, constituted data, a position, a dimension, a rotating angle, or indicating information; the different effects of the identification at least comprise the difference of a color, a line type, thickness or thinness, a transparency ratio, a shape, a content, a twinkling state, luminance, constituted data, a position, a dimension, a rotating angle, or indicating information; the difference of the indicating information at least comprises the difference of a color, a line type, thickness or thinness, a transparency ratio, a content, a twinkling state, luminance, a font, a position, a dimension, or a rotating angle; the different effects of the infrared thermal image at least comprise the difference of the pseudo color.

34. The device for detecting thermal images according to claim 29, wherein the detecting part is used for detecting specified information related to the specified body thermal image according to the acquired thermal imaging data frame, and the informing part is used for performing the informing control according to the specified information and/or an evaluation value acquired by the specified information.

35. The device for detecting thermal images according to claim 34, wherein the specified information at least comprises a position, a dimension, a rotating angle, a correlation degree value, an analysis value, or a combination thereof.

36. The device for detecting thermal images according to claim 29, wherein the detecting part detects if there is the specified body thermal image in the thermal imaging data frame according to a specified detecting area in the thermal imaging data frame, and the detecting area is set according to a position parameter of the reference image located in the infrared thermal image.

37. The device for detecting thermal images according to claim 29, further comprising:
a body information selecting part for selecting body information based on the body information stored in a storage medium, the storage medium being used for storing the body information and body identifying information related to the body information;
the detecting part for performing detection according to the body identifying information, related to the detection, which is configured based on the body identifying information related to the selected body information.

38. The device for detecting thermal images according to claim 29, further comprising:
a body information selecting part for selecting body information based on the body information stored in a storage medium, the storage medium being used for storing the body information and constituted data of the reference image related to the body information and/or body identifying information related to the body information;
the reference image displayed with the infrared thermal image being the reference image acquired according to the constituted data of the reference image related to the selected body information;
the detecting part for performing detection according to the body identifying information, related to the detection, which is configured based on the constituted data of the reference image and/or the body identifying information related to the selected body information.

39. The device for detecting thermal images according to claim 29, wherein the reference image is located in the infrared thermal image and with a specified position parameter.

40. The device for detecting thermal images according to claim 29, wherein the reference image reflects morphological character of a photographed body.

41. The device for detecting thermal images according to claim 29, wherein the thermal image detecting device is a portable thermal imaging device or an on-line thermal imaging device, and the acquiring part is a photographing part for acquiring the thermal image data frame via photographing.

42. A method for detecting thermal images, comprising:
an acquiring step for continuously acquiring a thermal imaging data frame;
a display controlling step for controlling to display a reference image and a dynamic infrared thermal image acquired by the acquired thermal imaging data frame;
a detecting step for detecting if there is a specified body thermal image in the thermal imaging data frame based on the acquired thermal imaging data frame;
an informing step for performing informing control when the specified body thermal image is detected in the detecting step.

43. The method for detecting thermal images according to claim 42, wherein the detecting step is used for detecting specified information related to the specified body thermal image according to the acquired thermal imaging data frame, the informing step is used for performing the informing control according to the specified information and/or an evaluation value acquired by the specified information, and the specified information at least comprises a position, a dimension, a rotating angle, a correlation degree value, an analysis value, or a combination thereof.

44. The method for detecting thermal images according to claim 42, wherein the informing step is used for controlling to generate a display change, to generate a sound reminder, to allow an indicator lamp to be twinkled, to generate vibration, to perform analysis, to perform diagnosis, to perform communication, or a combination thereof.

45. The method for detecting thermal images according to claim 44, wherein the informing step is used for controlling to generate the display change between a display interface after the specified body thermal image is detected and the display interface before the specified body thermal image is detected, and the display change comprises the display of the reference image with different effects or without the reference image, the display of an identification with different effects or without the identification, the display of different indicating information or without the indicating information, the display of the infrared thermal image with different effects, or a combination thereof.

46. The method for detecting thermal images according to claim 45, wherein the different effects of the reference image at least comprise the difference of a color, a line type, thickness or thinness, a transparency ratio, a shape, a content, a twinkling state, luminance, constituted data, a position, a dimension, a rotating angle, or indicating information; the different effects of the identification at least comprise the difference of a color, a line type, thickness or thinness, a transparency ratio, a shape, a content, a twinkling state, luminance, constituted data, a position, a dimension, a rotating angle, or indicating information; the difference of the indicating information at least comprises the difference of a color, a line type, thickness or thinness, a transparency ratio, a content, a twinkling state, luminance, a font, a position, a dimension, or a rotating angle; the different effects of the infrared thermal image at least comprise the difference of the pseudo color.

47. The method for detecting thermal images according to claim 42, further comprising:
a body information selecting step for selecting body information based on the body information stored in a storage medium, the storage medium being used for storing the body information and body identifying information related to the body information;
the detecting step for performing detection according to the body identifying information, related to the detection, which is configured based on the body identifying information related to the selected body information.

48. The method for detecting thermal images according to claim 42, wherein the reference image is located in the infrared thermal image and with a specified position parameter.
